(19) United States
(12) Patent Application Publication
(10) Pub. No.: US 2009/0108694 A1
(43) Pub. Date: Apr. 30, 2009

(54) ROTOR AND PUMP

(75) Inventor: Kazumichi HANAI, Nagoya-shi (JP)

Correspondence Address: DENNISON, SCHULTZ & MACDONALD, 1727 KING STREET, SUITE 105, ALEXANDRIA, VA, 22314, US

(73) Assignee: Aisan Kogyo Kabushiki Kaisha, Obu-shi (JP)

(21) Appl. No.: 12/251,606

(22) Filed: Oct. 15, 2008

(30) Foreign Application Priority Data
Oct. 31, 2007 (JP) 2007-284080

(51) Int. Cl. H02K 21/14

(52) U.S. Cl. 310/156.16

(57) ABSTRACT

A rotor for being used in a motor is provided with a shaft, a yoke attached to the shaft, a magnet attached to the yoke, and an elastic member attached to at least one of the shaft and the yoke. The elastic member forces the magnet towards the yoke along an axial direction of the shaft.

### CROSS-REFERENCE TO RELATED APPLICATION

This application claims priority to Japanese Patent Application No. 2007-284080 filed on Oct. 31, 2007, the contents of which are hereby incorporated by reference into the present application.

### BACKGROUND OF THE INVENTION

1. Field of the Invention

The present invention relates to a rotor that rotates within a casing of a motor and a pump in which the rotor is incorporated.

2. Description of the Related Art

A motor having a rotor and coils arranged around the rotor is well known. The rotor is provided with a shaft and a magnet secured to the shaft. In the rotor utilized in such a motor, since the magnet can be easily broken, the magnet should be secured to the shaft with less stress imposed on the magnet as much as possible. Therefore, how the magnet is secured to the shaft becomes a crucial issue.

Japanese Patent Application Publication No. 2005-217066 (hereinafter referred to as Patent Document 1) discloses a rotor having a shaft and a magnet. The magnet has a tubular shape. A coat layer is formed on a surface of the magnet. The shaft is pressed into a center hole of the magnet so as to secure the magnet to the shaft. In this rotor, at the time of pressing the shaft into the center hole of the magnet, it is alleged that breakage of the magnet can be suppressed because the force acting on the magnet is absorbed by the coat layer.

Japanese Patent Application Publication No. 2005-299559 (hereinafter referred to as Patent Document 2) discloses a rotor having a shaft, a magnet, and a main body. The main body and the magnet have a tubular shape. The main body is made of resin. The shaft is inserted into a center hole of the main body, and is secured to the main body. The main body is inserted into a center hole of the magnet. The magnet is secured to the main body by resin molded on the magnet. That is, by surrounding the magnet with molded resin, the magnet is secured to the main body.

### BRIEF SUMMARY OF THE INVENTION

A magnet in a tubular shape is easily broken when force acts along a direction of enlarging its center hole (i.e. a direction along the thickness of the outer peripheral portion surrounding the center hole). In the rotor of Patent Document 1, although the force acting on the center of the magnet is absorbed by the coat layer, force acts on the magnet along the direction of enlarging the center hole at the time of pressing the shaft into the center hole of the magnet. Therefore, when manufacturing the rotor, there is a problem that the breakage of the magnet cannot be completely prevented. Particularly, a magnet in a tubular shape having a thin outer peripheral portion is easily broken. Therefore, a thin magnet is not available.

In the rotor of Patent Document 2, by surrounding the magnet with the resin, the magnet is secured to the main body. Therefore, at the time of manufacturing the rotor, large force does not act on the magnet and the breakage of the magnet can be suppressed. However, in this rotor, at the time of rotating the rotor (when angular acceleration is imposed thereon), the force acts on a contact portion between the magnet and the main body. Therefore, usage of the rotor over long duration results in looseness generated between the magnet and the main body. There is a problem that the product life of the rotor is short.

A technique described in the present specification provides a rotor with long product life and endurance with respect to the breakage of magnet during manufacturing.

The rotor disclosed in this specification is used in a motor. The rotor comprises a shaft, a yoke attached to the shaft, a magnet attached to the yoke, and an elastic member attached to at least one of the shaft and the yoke. The elastic member forces the magnet towards the yoke along an axial direction of the shaft. In this rotor, the magnet is secured to the yoke by the elastic member that forces the magnet towards the yoke. Force imposed on the magnet by the elastic member is parallel to the axial direction of the shaft, thus the breakage of the magnet is prevented. Moreover, since the elastic member force supports the magnet, looseness in the attachment of the magnet is not caused even with long-term use of the rotor.

The rotor may comprise the following constitution. The magnet may be formed in a tubular shape and may comprise a center hole. The yoke may be inserted into the center hole and may comprise a contact portion protruding from an outer peripheral surface of the yoke. One end of the magnet may make contact with the contact portion and another end of the magnet may make contact with the elastic member. The magnet may be secured between the contact portion and the elastic member. It should be noted that the term “insert into a hole” in the present specification means to let the yoke and the like into the hole without any deformation. Therefore, in the case where the yoke is “inserted” into the center hole of the magnet, the force along the direction of enlarging the center hole of the magnet does not act thereupon. In this rotor, since the yoke is inserted into the center hole of the magnet in such a manner, the force does not act on the magnet along the direction of enlarging the center hole. The breakage of the magnet at the time of manufacturing the rotor may thus be prevented. In this rotor, one end of the magnet in the axial direction of the tubular shape makes contact with the contact portion of the yoke and another end in the opposite side of the axial direction makes contact with the elastic member, whereby the magnet is forced towards the contact portion. That is, the magnet is sandwiched and secured by the contact portion and the elastic member. The force from the elastic member acts on the magnet along the axial direction of the magnet. Since the magnet is impervious to the force acting along the axial direction, the breakage of the magnet thereof is prevented. Meanwhile, since the elastic member forces the magnet, looseness in the attachment of the magnet is not caused even with long-term use of the rotor. That is, in this rotor, the generation of ricketiness of the magnet is prevented and long product life is realized.

The rotor may comprise the following constitution. The yoke may be formed in a tubular shape and may comprise a shaft hole. The shaft may be pressed into the shaft hole. It should be noted that the term “press into a hole” in the present specification means to let the shaft and the like into the hole while being deformed. In other words, the above expression indicates that the shaft and the like having a diameter larger than the hole is inserted into the hole while being deformed. In this rotor, since the shaft is pressed into the shaft hole of the yoke, the yoke is firmly secured to the shaft. Therefore, generation of looseness between the shaft and the yoke can be prevented.

The rotor may comprise the following constitution. The magnet may comprise a second contact portion that makes contact with at least one of the yoke and the elastic member along a rotation direction of the rotor. In this rotor, since the second contact portion makes contact with the yoke and/or the elastic member in the rotation direction of the rotor, relative rotation of the magnet with respect to the yoke can be prevented.

The rotor may comprise the following constitution. The elastic member may comprise a through hole. The shaft or the yoke may be pressed into the through hole. In this rotor, since the shaft or the yoke is pressed into the through hole of the elastic member, the elastic member is firmly secured. Therefore, generation of looseness between the elastic member and the shaft or the yoke can be prevented.

The rotor may comprise the following constitution. A rust proof treatment may be carried out on the magnet. An outer peripheral surface of the magnet may be covered by resin. The outer peripheral surface of the magnet may be covered by a resin-made thermal contraction tube. The yoke may be made of magnetic material. The yoke may be made of metal. Further, the yoke may be made of iron or magnetic steel. The magnet may be made of a rare-earth bond magnet or a ferrite magnet.

According to any of the above-mentioned techniques, the rotor with long product life and endurance with respect to the breakage of the magnet during manufacturing can be achieved.

Further, a pump with long product life can be provided using the rotor described above. The pump draws and discharges liquid. The pump may comprise a motor unit and a pump unit. The motor unit may comprise a casing in which a rotor is housed. The pump unit may be driven by the motor unit. The rotor may comprise a shaft, a yoke attached to the shaft, a magnet attached to the yoke, and an elastic member attached to at least one of the shaft and the yoke. The elastic member may force the magnet towards the yoke along an axial direction of the shaft.

### BRIEF DESCRIPTION OF THE DRAWINGS

FIG. 1 is a schematic sectional view of a fuel pump 100.

FIG. 2 is a sectional view along a plan including a rotation axis of a rotor 10.

FIG. 3 is a sectional view along line III-III of FIG. 2.

FIG. 4 is a side view of the rotor 10 with tube 16 abbreviated.

FIG. 5 is a sectional view along line V-V of FIG. 2.

FIG. 6 is a plan view of a forcing member 15.

FIG. 7 is a side view corresponding to FIG. 4 showing the rotor 10 of a modified example.

FIG. 8 is a sectional view corresponding to FIG. 2 showing the rotor 10 of a modified example.

### DETAILED DESCRIPTION OF THE INVENTION

### Embodiment

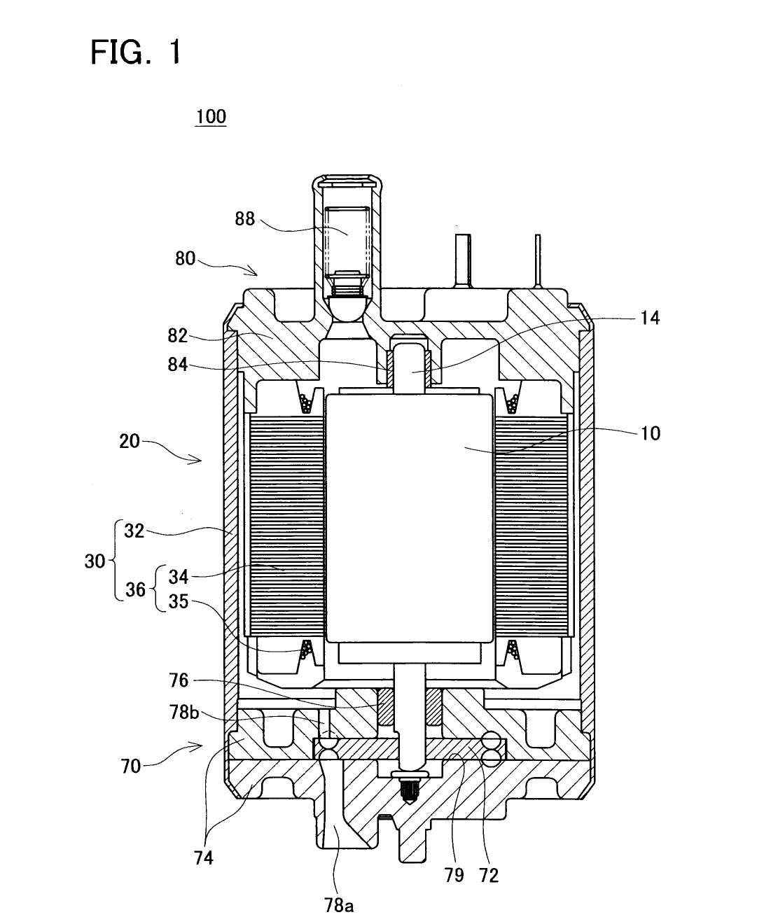

A rotor of an embodiment of the present teachings will be described with reference to the drawings. FIG. 1 is a schematic sectional view of a fuel pump 100 in which a rotor 10 of the present embodiment is incorporated. The fuel pump 100 is installed within a fuel tank of an automobile or the like, and used for supplying fuel within the fuel tank to an engine. The fuel pump 100 is formed of a pump unit 70, a motor unit 20 and a discharge unit 80.

As shown in FIG. 1, the motor unit 20 is provided with a casing 30 and a rotor 10 housed in the casing 30.

The rotor 10 is formed of a shaft 14, a yoke, a magnet (both of which are not shown in FIG. 1) and the like. The shaft 14 is rotatably supported within the casing 30. Thereby, the entire rotor 10 is capable of rotating within the casing 30. A detailed structure of the rotor 10 will be described later.

The casing 30 has a casing member 32 and a plurality of electromagnets 36. The casing member 32 has a cylindrical shape centering with the shaft 14 at its center. The casing member 32 surrounds the rotor 10. A plurality of the electromagnets 36 is secured to the inside of the casing member 32. The electromagnets 36 are arranged along a circumferential direction of the rotor 10 so as to surround the rotor 10. Each of the electromagnets 36 is formed by a core 34 and a coil 35 wound around the core 34. The core 34 and the rotor 10 are not in touch with each other, and a clearance is formed therebetween. Electric current can be supplied from unindicated exterior source to the coil 35.

The discharge unit 80 has a casing member 82. The casing member 82 is fitted into an upper part of the casing member 32. A shaft supporting unit 84 is formed inside the casing member 82. The shaft supporting unit 84 rotatably supports the shaft 14 at the upper side of the shaft 14. A fuel discharge port 88 is formed in an upper part of the casing member 82.

The pump unit 70 has an impeller 72 and a pump casing 74 in which the impeller 72 is housed. A shaft supporting unit 76, an impeller housing chamber 79, a fuel intake opening 78a and a fuel discharge opening 78b are formed in the pump casing 74. The impeller 72 is housed in the impeller housing chamber 79. The shaft supporting unit 76 rotatably supports the shaft 14 at the lower side of the shaft 14. The shaft 14 extends into the inside of the impeller housing chamber 79 and is engaged with the impeller 72 within the impeller housing chamber 79. Thereby, the impeller 72 is capable of rotating together with the shaft 14. The fuel intake opening 78a communicates the impeller housing chamber 79 with the exterior environment of the fuel pump 100. The fuel discharge opening 78b communicates the impeller housing chamber 79 with the inside of the motor unit 20.

For operating the fuel pump 100, the electric current is supplied to the electromagnets 36. That is, the electric current is supplied to the coils 35 wound around the cores 34. At this time, since the electric current is supplied to the electromagnets 36 arranged along a circumferential direction of the rotor 10 in the order of arrangement thereof, a magnetic field rotating around an axis of the shaft 14 is generated in the motor unit 20. Then, the rotating magnetic field and a magnetic field of the magnet of the rotor 10 act upon each other, which in consequence the rotor 10 is rotated (i.e. the shaft 14 is rotated). With the shaft 14 being rotated, the impeller 72 is consequently rotated. When the impeller 72 is rotated within the pump casing 74, fuel is drawn from the fuel intake opening 78a into the inside of the impeller housing chamber 79. Pressure of the fuel drawn into the inside of the impeller housing chamber 79 is boosted by rotation of the impeller 72, and the fuel is fed from the fuel discharge opening 78b to the inside of the motor unit 20. The fuel fed to the motor unit 20 flows through the inside of the motor unit 20, and is discharged from the fuel discharge port 88 to the exterior environment.

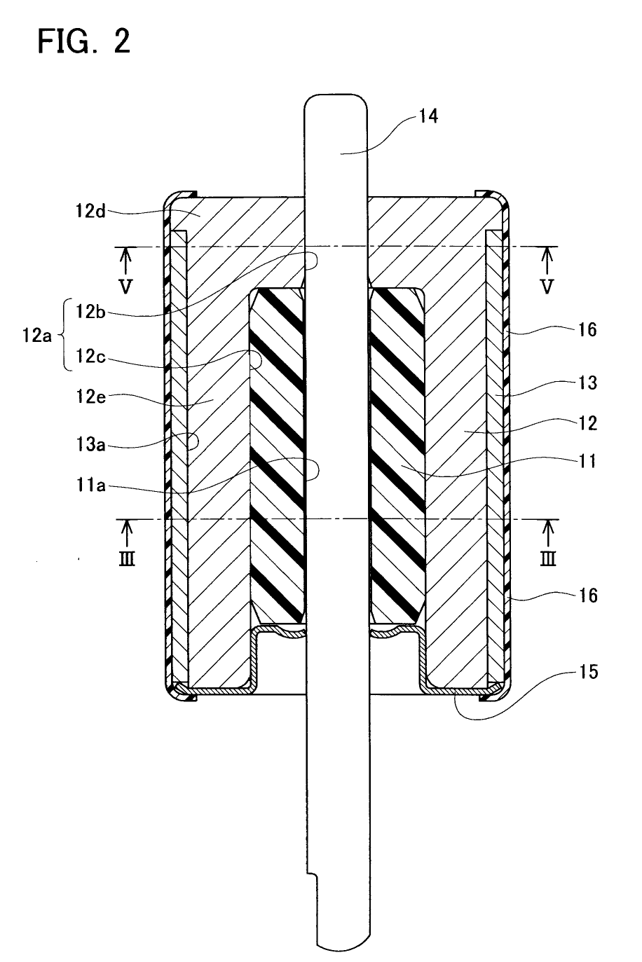

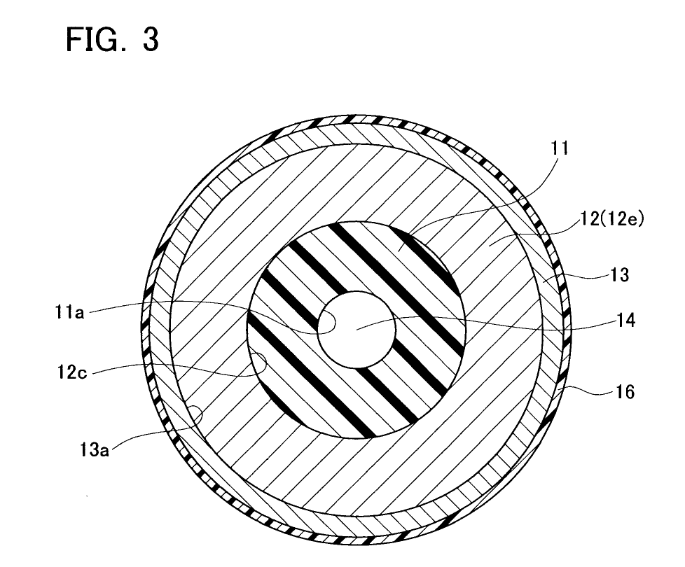

Next, the detailed structure of the rotor 10 will be described. FIG. 2 shows a sectional view along a rotation axis of the rotor 10. FIG. 3 shows a sectional view taken along line III-III of FIG. 2. As shown in FIGS. 2 and 3, the rotor 10 has the shaft 14, an adapter 11, a yoke 12, a magnet 13, a forcing member 15 and a tube 16.

As shown in FIGS. 2 and 3, the adapter 11 has a cylindrical shape. The adapter 11 is made of resin. The shaft 14 is pressed into a through hole 11a of the adapter 11. Thereby, the adapter 11 is secured to the shaft 14.

As shown in FIGS. 2 and 3, the yoke 12 has a substantially cylindrical shape. The yoke 12 is made of iron. A shaft hole 12a of the yoke 12 is formed by a small diameter hole 12b and a large diameter hole 12c. The shaft 14 is pressed into the small diameter hole 12b. Thereby, the yoke 12 is secured to the shaft 14. As shown in FIG. 2, the yoke 12 is secured at a position where the adapter 11 is housed in the large diameter hole 12c. Moreover, the yoke 12 has a large diameter portion 12d and a small diameter portion 12e. As shown in FIG. 2, the diameter of the large diameter portion 12d (i.e. the diameter of an outer peripheral surface thereof) is larger than that of the small diameter portion 12e. It may also be described that the large diameter portion 12d protrudes outward from the outer peripheral surface of the small diameter portion 12e.

As shown in FIGS. 2 and 3, the magnet 13 has a cylindrical shape. The magnet 13 is made of a rare-earth bond magnet. The small diameter portion 12e of the yoke 12 is inserted into a center hole 13a of the magnet 13. That is, a diameter of the center hole 13a is formed so as to be slightly larger than the diameter of the small diameter portion 12e. Therefore, in a state where the forcing member 15 is not attached, the magnet 13 is capable of sliding with respect to the yoke 12. The magnet 13 is secured in a state in which one distal end of the magnet 13 is making contact with the large diameter portion 12d of the yoke 12. A diameter of an outer peripheral surface of the magnet 13 is substantially equal to the diameter of the large diameter portion 12d of the yoke 12. A surface of the magnet 13 is coated by polyamide-imide resin having thickness of approximately 30 μm so that rusting of the magnet 13 is prevented.

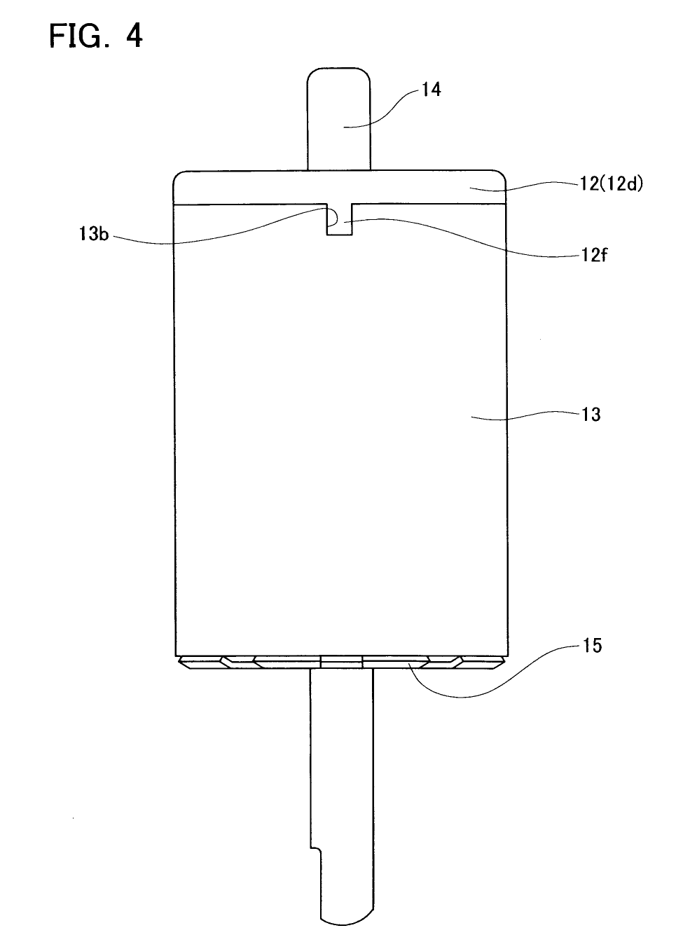

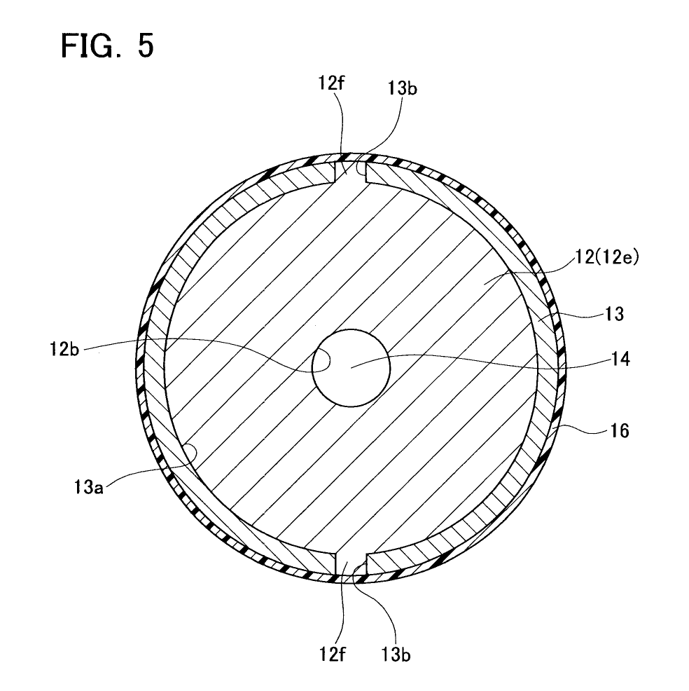

FIG. 4 shows a side view of the rotor 10 in a state in which the tube 16 is not attached. FIG. 5 shows a sectional view taken along line V-V of FIG. 2. As shown in FIGS. 4 and 5, a cutout portion 13b is formed at one end of the magnet 13 on the side of the large diameter portion 12d. The cutout portion 13b extends in parallel to the shaft 14. An extending portion 12f extending from the large diameter portion 12d is formed in the yoke 12. The extending portion 12f extends in parallel to the shaft 14. As shown in the figures, the extending portion 12f is fitted into the cutout portion 13b. Width of the cutout portion 13b is formed so as to be slightly larger than width of the extending portion 12f. Therefore, in a state where the rotor is ceased in a still state, there is almost no force acting between the extending portion 12f and the cutout portion 13b.

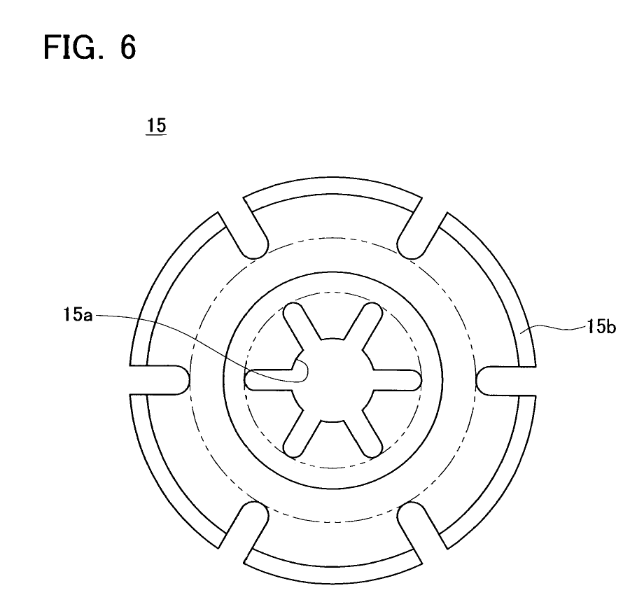

As shown in FIG. 2, the forcing member 15 is secured to the shaft 14 at a position opposite to the large diameter portion 12d of the yoke 12 (i.e. the lower side of FIG. 2). The forcing member 15 is made of elastic material, in detail, of metal. FIG. 6 shows a plan view of the forcing member 15. As shown in the figure, a through hole 15a is formed at the center of the forcing member 15. As shown in FIG. 2, the shaft 14 is pressed into the through hole 15a. Thereby, the forcing member 15 is secured to the shaft 14. As shown in FIG. 6, six forcing portions 15b are formed at an outer peripheral part of the forcing member 15. The forcing portions 15b can be elastically bent along the thickness direction of the forcing member 15 (a direction parallel to the shaft 14 of FIG. 2). As shown in FIG. 2, outer rims of the forcing portions 15b make contact with the distal end (i.e. the lower end of FIG. 2) of the magnet 13. Thereby, the magnet 13 is forced towards the large diameter portion 12d of the yoke 12, and secured by being caught in between the large diameter portion 12d and the forcing member 15 in the axial direction of the shaft 14. That is, when the forcing member 15 is attached to the shaft 14, the shaft 14 is pressed from the lower side of FIG. 2 into the through hole 15a of the forcing member 15. When the forcing member 15 is brought close to the yoke 12, the outer rims of the forcing portions 15b firstly make contact with the distal end of the magnet 13. In this state, the forcing member 15 except for the outer rims of the forcing portions 15b does not make contact with any of the adapter 11, the yoke 12 and the magnet 13. From this state, when the forcing member 15 is further pressed towards the yoke 12, the forcing portions 15b are elastically bent. Therefore, the forcing member 15 comes in touch with the adapter 11 and the yoke 12, and hence is secured in a state of FIG. 2. As a result, the magnet 13 is forced towards the large diameter portion 12d by the elastically bent forcing portions 15b. That is, one end of the magnet 13 along an axial direction (the upper end in FIG. 2) makes contact with the large diameter portion 12d of the yoke 12, another end of the magnet 13 along an axial direction (the lower end in FIG. 2) makes contact with the forcing member 15, and the magnet 13 is forced towards the large diameter portion 12d. Thereby, the magnet 13 is sandwiched and secured by the large diameter portion 12d and the forcing member 15.

As shown in FIG. 2, the tube 16 covers the outer peripheral surface of the magnet 13. The tube 16 is a thermal contraction tube made of polyethylene terephthalate. When attaching the tube 16, the rotor 10 with bare outer surface is inserted into the tube 16 that is yet to be contracting. Then, the tube 16 is heated together with the rotor 10; thereby the tube 16 is contracted and secured in a state of covering the outer peripheral surface of the magnet 13. When the rotor 10 is installed within the motor unit 20 at the time of assembling the fuel pump 100, the rotor 10 is sucked to and makes contact with the casing 30 by the magnetic force of the magnet 13. At this time, the tube 16 prevents occurrence of scratches on the surface of the magnet 13 and paring off of the polyamide-imide resin coating (rust proof coating). Therefore, at the time of using the fuel pump 100, undesirable condition rising due to the rust of the magnet 13 is prevented.

According to the rotor 10 mentioned above, breakage of the magnet 13 can be prevented during manufacturing, and the rotor 10 is able to achieve long product life. In the aforementioned rotor 10, the small diameter portion 12e having the smaller diameter than the center hole 13a of the magnet 13 is inserted into the center hole 13a. Therefore, force does not act on the magnet 13 along the direction of enlarging the center hole 13a. Consequently, the breakage of the magnet 13 during fabrication can be prevented. Additionally, the magnet 13 is caught and secured between the large diameter portion 12d and the forcing member 15 by the supporting force imposed by the forcing member 15. That is, the force for securing the magnet 13 acts along the axial direction of the cylindrical shape of the magnet 13. The magnet 13 in a cylindrical shape is generally weak against force acting in the direction from the center hole 13a towards an outer peripheral part (that is, force acting along radial direction), but strong against force acting along the axial direction. Therefore, the magnet 13 can be sandwiched with relatively large force and thereby be surely secured. Furthermore, since the magnet 13 is secured by the force of the forcing member 15, even when the contacting surface between the magnet 13 and the large diameter portion 12d is worn away due to repetitive use of the rotor 10, looseness thereof is not generated. Furthermore, since the yoke 12 and the forcing member 15 are secured to the shaft 14 by pressing, there is no looseness in the yoke 12 and the forcing member 15 with respect to the shaft 14. That is, in the rotor 10, looseness generation is prevented even with long-term usage, and long product life is thus realized.

In the case where the rare-earth bond magnet (the magnet 13) is formed in a cylindrical shape, the magnet can be formed with high accuracy in size along a radial direction, but generally has poor accuracy in size along its axial direction. In general, there is a size error of approximately 1% with respect to the length of the magnet 13 along the axial direction. In the rotor 10 mentioned above, the magnet 13 is secured with utilizing elastic bending of the forcing member 15. Therefore, even with the poor accuracy in lengthwise size of the magnet 13 along the axial direction, the magnet 13 can be firmly secured without any ricketiness occurring.

The magnet 13 is engaged with the extending portion 12f of the yoke 12 in the cutout portion 13b. The cutout portion 13b makes contact with the yoke 12 in a rotation direction of the rotor 10. Therefore, when the rotor 10 is rotated at high angular acceleration, relative rotation of the magnet 13 with respect to the yoke 12 is prevented (hereinafter, this rotation is referred to as idle rotation of the magnet 13). Further, the force of the forcing member 15 also prevents the idle rotation of the magnet 13 at this time, and thereby no excessive force acts on the extending portion 12f. Therefore, the looseness generation between the extending portion 12f and the cutout portion 13b is suppressed.

Since the yoke 12 is composed of iron (that is, the magnetic material), spread of magnetic flux from the magnet 13 is prevented, and thereby the magnetic force of the magnet 13 can effectively imposed. Further, the magnetic force acts between the magnet 13 and the yoke 12, and thereby relative rotation of the magnet 13 with respect to the yoke 12 is prevented. Since the yoke 12 is iron (i.e. metal), the yoke 12 can be tightly secured to the shaft 14 by pressing.

It should be noted that in the embodiment mentioned above, although the yoke 12 is made of iron, the yoke 12 may be made of ferromagnetic material such as magnetic steel.

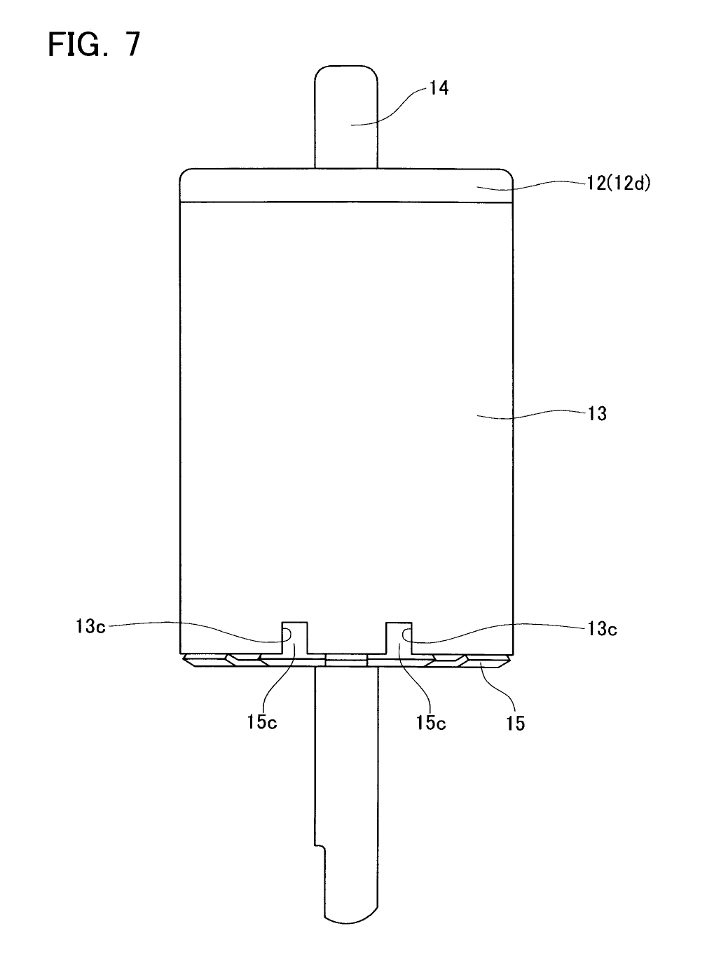

In the embodiment mentioned above, a contact portion for preventing the idle rotation of the rotor 10 (e.g. the cutout portion 13b and the extending portion 12f) is formed in the contacting part between the large diameter portion 12d and the magnet 13. However, as shown in FIG. 7, the contact portion (e.g. a cutout portion 13c and an extending portion 15c) may alternately be provided in a contacting part between the magnet 13 and the forcing member 15. Also by such a constitution, the idle rotation of the magnet 13 can be prevented.

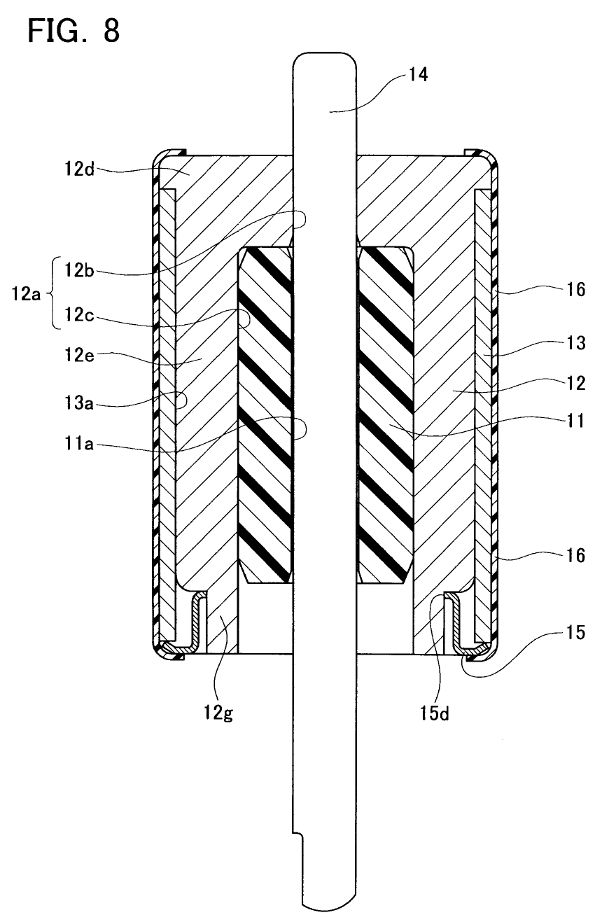

In the embodiment mentioned above, the forcing member 15 is secured to the shaft 14. However, as shown in FIG. 8, the forcing member 15 may alternately be secured to the yoke 12. In FIG. 8, the forcing member 15 is secured to the yoke 12 with a second small diameter portion 12g of the yoke 12 pressed into a through hole 15d of the forcing member 15.

Furthermore, in the embodiment mentioned above, the magnet 13 is made of the rare-earth bond magnet. However, other magnets such as a ferrite magnet may be used.

Finally, although the preferred representative embodiment has been described in detail, the present embodiment is for illustrative purpose only and is not restrictive. It is to be understood that various changes and modifications may be made without departing from the spirit or scope of the appended claims. In addition, the additional features and aspects disclosed herein also may be utilized singularly or in combination with the above aspects and features.

What is claimed is:

1. A rotor for being used in a motor, the rotor comprising:
a shaft;
a yoke attached to the shaft;
a magnet attached to the yoke; and
an elastic member attached to at least one of the shaft and the yoke, the elastic member forcing the magnet towards the yoke along an axial direction of the shaft.

2. The rotor as in claim 1, wherein
the magnet is formed in a tubular shape and comprises a center hole,
the yoke is inserted into the center hole and comprises a contact portion protruding from an outer peripheral surface of the yoke, and
one end of the magnet makes contact with the contact portion and another end of the magnet makes contact with the elastic member, the magnet is secured between the contact portion and the elastic member.

3. The rotor as in claim 1, wherein
the yoke is formed in a tubular shape and comprises a shaft hole, and
the shaft is pressed into the shaft hole.

4. The rotor as in claim 1, wherein
the magnet comprises a second contact portion that makes contact with at least one of the yoke and the elastic member along a rotation direction of the rotor.

5. The rotor as in claim 1, wherein
a rust proof treatment is carried out on the magnet, and
an outer peripheral surface of the magnet is covered by resin.

6. The rotor as in claim 1, wherein
the yoke is made of magnetic material.

7. The rotor as in claim 1, wherein
the yoke is made of metal.

8. The rotor as in claim 1, wherein
the elastic member comprises a through hole, and
the shaft or the yoke is pressed into the through hole.

9. The rotor as in claim 1, wherein
one of the yoke and the magnet comprises at least one cutout portion extending along the axial direction of the shaft, the other of the yoke and the magnet comprises at least one extending portion extending along the axial direction of the shaft, and the cutout portion engages with the extending portion.

10. A pump for drawing and discharging liquid, the pump comprising:
a motor unit comprising a casing in which a rotor is housed; and
a pump unit driven by the motor unit,
wherein the rotor comprises:
a shaft;
a yoke attached to the shaft;
a magnet attached to the yoke; and
an elastic member attached to at least one of the shaft and the yoke, the elastic member forcing the magnet towards the yoke along an axial direction of the shaft.
